(19) United States
(12) Patent Application Publication
(10) Pub. No.: US 2018/0032568 A1
(43) Pub. Date: Feb. 1, 2018

(54) Computing System with Multi-Processor Platform for Accelerating Influence Maximization Computation and Related Methods

(71) Applicant: Sysomos L.P., Toronto (CA)

(72) Inventors: Koushik PAL, Etobicoke (CA); Zisis Paraskevas POULOS, Toronto (CA)

(73) Assignee: Sysomos L.P., Toronto (CA)

(21) Appl. No.: 15/659,893

(22) Filed: Jul. 26, 2017

Related U.S. Application Data
(60) Provisional application No. 62/368,816, filed on Jul. 29, 2016.

(51) Int. Cl. G06F 17/30; G06Q 50/00

(52) U.S. Cl. CPC G06F 17/30371; G06F 17/30876; G06Q 50/01

(57) ABSTRACT

The influence spread can be efficiently increased, or even maximized, by utilizing a multi-processing platform such as a GPU (e.g. Graphics Processing Unit), multi-core processor, etc. It is herein provided that a large graph of a social data network comprising nodes (e.g. the user accounts) and edges (e.g. the data links or relationships between the user accounts) may be separated into local subgraph trees, and that these local subgraph trees may be independently processed in parallel threads on the multi-processing platform. A particular example of such a platform is a GPU-based environment that includes many threads.

### CROSS-REFERENCE TO RELATED APPLICATIONS

This application claims priority to U.S. Provisional Patent Application No. 62/368,816 filed on Jul. 29, 2016, entitled “Computing System with Multi-Processor Platform for Accelerating Influence Maximization Computation and Related Methods” and the entire contents of which is incorporated herein by reference.

### TECHNICAL FIELD

The following relates to accelerating influence maximization using a multi-processor platform.

### DESCRIPTION OF THE RELATED ART

In recent years social media has become a popular way for individuals and consumers to interact online (e.g. on the Internet). Social media also affects the way businesses aim to interact with their customers, fans, and potential customers online.

In social data networks, such as those platforms under the trade names Facebook, Twitter, LinkedIn, Instragram, etc., user accounts have relationships with each other. For instance, these massive social networks include billions of users (e.g. data nodes) and trillions of edges (e.g. data links) representing interactions, dictating opinions, and causing viral explosions. Quickly identifying relevant target groups and/or popular or influential individuals, and accurately identifying influential individuals that should be targeted initially, such that an expected number of follow-ups is maximized for a particular topic, can be difficult and computationally expensive, particularly as number of users within a social network grows.

In particular, there are some user accounts that are considered more influential. In other words, a digital message transmitted by an influential user will have a greater spread to a higher number of other user accounts in the social data network. For example, in a given social data network, a user account belonging to a celebrity (e.g. Justin Bieber) or to a brand-name company (e.g. Coca-Cola) will usually have a larger spread when transmitting digital messages. It is difficult for computers to automatically identify which user accounts provide the most spread (e.g. reach the largest number of other user accounts), especially when also considering other constraints (e.g. costs and time).

### BRIEF DESCRIPTION OF THE DRAWINGS

Embodiments will now be described by way of example only with reference to the appended drawings wherein:

FIG. 1 is a schematic diagram of a data architecture and system for identifying seed users to increase or maximize spread in social networks;

FIGS. 2-4 is a flow diagram of example computer executable or processor implemented instructions.

FIG. 5 is a schematic diagram of a computing system showing devices for implementing the instructions.

FIGS. 6A-6D show example experimental results.

FIGS. 7A-7C show example experimental results.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

In an example embodiment of the proposed system, the influence spread can be efficiently increased, or even maximized, by utilizing a multi-processing platform such as a GPU (e.g. Graphics Processing Unit), multi-core processor, etc. It is herein provided that a large graph of a social data network comprising nodes (e.g. the user accounts) and edges (e.g. the data links or relationships between the user accounts) may be separated into local subgraph trees, and that these local subgraph trees may be independently processed in parallel threads on the multi-processing platform. A particular example of such a platform is a GPU-based environment that includes many threads.

It is herein recognized that there are existing computing approaches for determining influence maximization. From a data mining standpoint, some approaches use heuristics for selecting a set of influential customers that can trigger adoption of an opinion or product over a large portion of the network. Typically, existing approaches formulate the influence maximization as a discrete optimization problem, and show that obtaining optimal solutions under various propagation models is NP-hard.

What appears to be common across existing computing frameworks is that these are based on discrete-time models. As such, as recognized herein, they are restricted in terms of capturing the temporal dynamics of influence diffusion. These approaches tend to solely rely on discrete variables, which are far less suitable for modeling the asynchronous nature of influence propagation compared to continuous variables. Further, such models assume an exponential or power-law distribution as the underlying model that characterizes node-to-node transmission times. Along these lines, recent studies on real world data has argued that continuous-time models offer substantial improvements over discrete-time ones for predicting how future events evolve in time and uncovering hidden temporal properties in cascade data.

Nevertheless, it is herein recognized that influence maximization based on continuous-time models is a challenging and computationally resource-intensive process (e.g. using high processing power, processing time, and memory resources). Estimating the spread of influence from each node is related to marginalization of continuous variables over loopy graphical models, which is known to be a #P-complete problem. Additionally, maximizing influence in the continuous-time domain is, at its core, a loopy belief propagation process, which is NP-hard.

While some existing approaches mitigate the scalability issue using a randomized neighborhood size estimation algorithm to approximate influence, it was shown that, when used as a subroutine in the well-established greedy approach, such an existing approach can reduce the number of computational steps required for maximization up to a factor of O(|ε|) compared to naïve sampling approaches. However, it is herein recognized that this comes at a cost of maintaining memory-intensive data structures for fast-querying the neighborhood sizes of each node during sampling rounds. As such, despite being orders of magnitude faster compared to other existing approaches, using randomized neighbourhood size estimation is not suitable for serial computing.

It is also recognized that some existing approaches necessitate the use of massive and expensive parallel utilities to become practical (e.g., hundreds of CPU clusters). It is also recognized that that these existing approaches are memory-intensive and therefore prohibit, to a significant extent, parallel processing by means of GPU or multi-GPU systems. It should be recognized that while GPU systems are proficient at parallel processing, they can do so for smaller amounts of data and, therefore, are not suitable for memory-intensive applications.

In an example embodiment, the proposed system is based on a continuous-time generative model for network diffusion. In this setting, each directed edge (u,v) is associated with a transmission density over time that models the time it takes for node u to influence node v given that node u has been previously influenced in the cascade. Network diffusion in this model is based on the continuous-time independent cascade model (ICM), which we restate here.

### Continuous-Time Independent Cascade

Suppose that the topology of the social network at hand is modeled as a directed graph, G=(V,E). The influence propagation process begins at time zero, when an initial set of source nodes, S, is already assumed to be influenced by means of adopting an opinion. This initial set of source nodes is referred to as the seed set, and it is assumed that S⊂V, or the influence process would trivially terminate at time zero.

Influence, then, propagates via directed edges from the seed nodes towards their out-neighbours. The spread of influence from node u to a direct out-neighbor v is assumed to consume random time ΔTᵤᵥ=tᵥ−tᵤ, where tᵤ and tᵥ indicate the timestamps when nodes u and v are influenced, respectively. In the continuous-time setting, ΔTᵤᵥ is sampled from the conditional density over time, D(ΔTᵤᵥ), of node v being influenced at time tᵥ given that node u was influenced at time tᵤ. In the above sense, each directed edge (u,v)εE is associated with D(ΔTᵤᵥ). There are two further assumptions embedded in this model: (a) the conditional density is time-shift invariant and non-negative, and (b) each influenced node remains in the influenced state for the duration of the diffusion process. The latter means that only the node that influences node v at the earliest time will be its parent in the induced influence cascade, effectively imposing a Directed Acyclic Graph (DAG) cascade structure, even if G contains loops.

### Shortest Path Property in the Continuous-Time ICM

A property of the continuous-time model is that, for a given sampling round across all edges, the time tᵤ it takes to influence node u is the length of the shortest path from the seed set to node u. This shortest path property is leveraged for influence spread estimation and is also utilized in the example systems and methods proposed herein, as it reduces the approximation of influence spread to a well-studied graphical optimization problem.

### Example Methodology

A primary assumption is that the computing system has a directed graph G=(V,E) with an exponential distribution fₑ(x)=λₑe^{-λex} on each edge e, where the parameter λₑ of the exponential distribution depends on the corresponding edge e. The distribution on the directed edge e=\vec{(u,v)} is supposed to model the time taken by u to influence v. The goal is to find a set of S nodes that has the maximum influence in a given time deadline T. The number S is determined by budget and other constraints.

A step in solving this problem is to compute the influence spread of each node of the graph G. One basic way to doing that is via Naïve Sampling, where a computer system generates a random sample of edge weights from the given edge distributions, computes the influence spread of each node for that sample as the number of nodes that have a shortest path from the given node of length less than the deadline T, repeats the process several times (say, Nₛ times), and finally computes the average spread of each node across all Nₛ samples. For the sake of completeness, we detail the Naïve Sampling algorithm below in Algorithm 1.

Unfortunately, Naïve Sampling is extremely computationally resource intensive (e.g. processor and memory resources) as it runs a single source shortest path algorithm from each node for each simulation. Dijkstra's algorithm, the fastest known algorithm for computing single source shortest paths on an arbitrary directed graph with unbounded nonnegative weights, has a time complexity of O(|E|+|V|log|V|). Consequently, Naïve Sampling has a time complexity of O(|Nₛ∥V|(|E|+|V|log|V|)), which is clearly immensely computationally resource intensive.

Algorithm 1 Naïve Sampling

| | |
|---|---|
| 1: | procedure N_{AIVE}S_{AMPLING}(G, T) |
| 2: | for i = 1 : number_of_vertices do |

| | |
|---|---|
| 3: | reach[i] = 0 |

| | |
|---|---|
| 4: | for n = 1 : number_of_samples do |

| | |
|---|---|
| 5: | Generate a sample W of weights for the edges in G from the |

corresponding edge distributions

| | |
|---|---|
| 6: | for i = 1 : number_of_vertices do |

| | |
|---|---|
| 7: | for j = 1 : number_of_vertices do |
| 8: | distance[j] = ∞ |

| | |
|---|---|
| 9: | Run single source shortest path algorithm from source node i based |
| | on the generated weights W |
| 10: | for j = 1 : number of vertices do |

| | |
|---|---|
| 11: | if distance[j] < T then |
| 12: | reach[i] = reach[i] + 1 |

| | |
|---|---|
| 13: | for i = 1 : number of vertices do |

| | |
|---|---|
| 14: | reach[i] = reach[i] / number_of_samples |

| | |
|---|---|
| 15: | return reach[ ] |

A much better and faster method to computing the average influence spread of each node is via Cohen's Neighborhood Size Estimation algorithm, which is a clever modification of Dijkstra's algorithm. It computes the influence spread of all nodes for a given sample in O(|V|+|E|) time complexity, and hence requires O(|Nₛ|(|V|+|E|)) time complexity to compute the average influence spread of all nodes across all samples.

An important point to note is that, despite its awfully bad time complexity, Naïve Sampling has two good qualities:
The space complexity of Naïve Sampling is only O(|V|+|E|), which is minimal.
It is hugely parallelizable. The computations for the different samples are totally independent of each other and can be run in parallel. Also, for a given sample, the single source shortest paths from different source nodes are mutually independent of each other, and can be run in parallel too.

Cohen's algorithm is also parallelizable across different samples, but it is not parallelizable across different nodes for a given sample. Moreover, Cohen requires a fancy data structure, called the least label lists, that requires O(|Nₛ∥E|) space—a huge space requirement, particularly for large graphs.

The computing methodology proposed herein is, instead, a variant of Naïve Sampling that achieves a middle ground between the above two alternatives. The proposed methodology improves Naïve Sampling on time complexity and Cohen on space complexity. Further, the proposed computing method is hugely parallelizable, and by parallelizing it, the computing systems achieve much better time complexity than Cohen, primarily on large graphs. The main idea is to run Dijkstra only once with the means of the edge distributions as the corresponding weights for each edge, and use that to select a “large enough” subgraph for each node where its primary influence within the given deadline T lies. Looking for influence spread in a smaller subgraph already reduces the computing system's computations a lot. To simplify matters further, the subgraph used by the computing system is a portion of the Dijkstra tree obtained while running Dijkstra. Computing the shortest path between two nodes in a tree is extremely computationally easy (e.g. little strain on processor and memory resources) for a computing system as there is exactly one path between any two nodes in a tree, and therefore, does not require any fancy shortest path algorithm. Then, the computing system simply generates multiple weight samples for that subgraph and computes the average influence spread of that node in that subgraph over all those samples. Clearly, this outputs an approximate spread for each node as opposed to its true spread. But that does not affect the computing system's selection of good seeds, as the below experimental results show.

We summarize an example embodiment of the algorithm in Algorithm 2.

Algorithm 2 Local Naïve Sampling

| | |
|---|---|
| 1: | procedure L_{OCAL}N_{AIVE}S_{AMPLING}(G, T, σ) |
| 2: | for l = 1 : number_of_vertices do |

| | |
|---|---|
| 3: | reach[i] = 0 |
| 4: | Assign weights W to all edges of G equal to the means of the |

corresponding edge distributions

| | |
|---|---|
| 5: | dijkstraTree[i] = DijkstraTree(i,G,W,T,σ) |

| | |
|---|---|
| 6: | Parallel Block: |
| 7: | for l = 1 : number_of_vertices do |

| | |
|---|---|
| 8: | for n = 1 : number_of_samples do |
| 9: | Generate a sample of weights for the edges in dijkstraTree[i] |

from the corresponding edge distributions

| | |
|---|---|
| 10: | for j = 1 : \|\|dijkstraTree[i]\|\| do |

| | |
|---|---|
| 11: | k = dijkstraTree[i][j] |
| 12: | Compute the distance of k from i in dijkstraTree[i] based |

on the generated weights

| | |
|---|---|
| 13: | if distance[k] < T then |
| 14: | reach[i] = reach[i] + 1 |

| | |
|---|---|
| 15: | reach[i] = reach[i] / number_of_samples |

| | |
|---|---|
| 16: | return reach[ ] |

### Choosing a Local Subgraph

An example computational method of selecting a proper local subgraph for each node is detailed below in Algorithm 3. The main idea is that the computing system uses the means of the exponential distributions on the edges as weights to find the nodes that are “within reach” of a given node. This local subgraph is where the computing system generates samples to compute the given node's influence spread, and so we want to make sure that we cover most of the actual nodes in the original graph that are within reach of that node in this subgraph. To that end, the computing system automatically selects nodes that have a shortest path from the given node of length “slightly more” than the deadline. The precise criterion for selecting such nodes is mentioned in Algorithm 3 (see lines 13 and 25).

Algorithm 3 Dijkstra Trees

| | |
|---|---|
| 1: | procedure D_{IJKSTRA}T_{REES}(source, G, W, T, σ) |
| 2: | distance[source] = 0 |
| 3: | variance[source] = 0 |
| 4: | create vertex set Q |
| 5: | for i = 1 : number_of_vertices do |

| | |
|---|---|
| 6: | if i ≠ source then |
| 7: | distance[i] = ∞ |
| 8: | variance[i] = ∞ |
| 9: | parent[i] = U N D E F I N E D |
| 10: | Q.add_with_priority(i, distance[i]) |

| | |
|---|---|
| 11: | while Q is not empty do |

| | |
|---|---|
| 12: | i = Q.extract_min( ) |
| 13: | if distance[i] − σ * \sqrt{variance[i]} ≧ T then |
| 14: | break |
| 15: | for each neighbor j of i do |
| 16: | alt_distance = distance[i] + W (i, j) |
| 17: | if alt_distance < distance[j] then |

| | |
|---|---|
| 18: | distance[j] = alt_distance |
| 19: | parent[j] = i |
| 20: | distance[i] − σ * \sqrt{variance[i]} + W (i, j)² |
| 21: | Q.decrease_priority(j, alt_distance) |

| | |
|---|---|
| 22: | dijkstraTree = [ ] |
| 23: | dijkstraTree.add([source; source]) |
| 24: | for i = 1 : number_of_vertices except source do |

| | |
|---|---|
| 25: | if distance[i] − σ * \sqrt{variance[i]} < T then |
| 26: | dijkstraTree.add([i, parent[i]]) |

| | |
|---|---|
| 27: | return dijkstraTree[ ] |

### Example Computing System and Computations

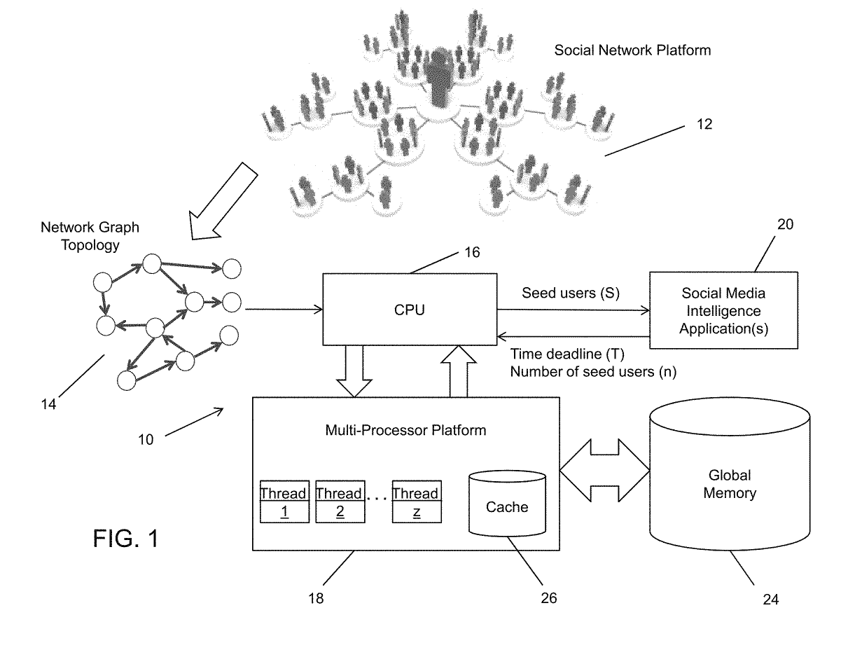

Turning now to the figures, FIG. 1 illustrates a data infrastructure and computing system 10 for determining which user accounts would be seed users S that should be targeted for a message campaign to provide the largest spread of the message in a social network platform 12. The social network platform 12 is represented using a network graph 14, that typically includes a continuously evolving topology that is used to estimate the influence spread in that social network at that time. The graph comprises nodes and edges, and each edge is associated with a distribution. The system 10 includes a central processing unit (CPU) 16 and a multi-processor platform 18 such as a general purpose graphics processing unit (GPU hereinafter), multi-core processor, etc. to estimate the influence spread using edge and node information in the network graph.

In this example illustration, the social media intelligence application 20 transmits a time deadline T and the number of seed users n to the CPU 16, expecting to obtain in return the set of seed users S. The time deadline T is the deadline in which the digital message must obtain the desired optimal spread. For example, within a certain time, the digital message should have reached all the desired users in the social network platform 12. The CPU 16, in collaboration with the multi-processor platform, determine the seed users S. After obtaining the seed users S, the social media intelligence application will send a digital message to the seed users S to affect or influence the other user accounts on the social network platform 12.

It will be appreciated that the digital message is any form of digital content. Non-limiting examples include one or more of a Tweet, a text message, a posting, an image, an audio file, a video, a tag, a location, etc.

It can be appreciated that the system 10 and application(s) 20 can be integrated into a single computing system, or may be part of separate computing systems. The multi-processor platform 18 includes a number of processing entities (e.g., threads, processors, etc.) and a memory cache 26. The multi-processor platform 18 is coupled or otherwise connected to a global memory 24 to store the results of data computations as described in greater detail below.

Social networking platforms 12 include users who generate and post content for others to see, hear, etc. (e.g. via a network of computing devices communicating through websites associated with the social networking platform). Non-limiting examples of social networking platforms 12 are Facebook, Twitter, LinkedIn, Pinterest, Tumblr, Instagram, blogospheres, websites, collaborative wikis, online newsgroups, online forums, emails, and instant messaging services. Currently known and future known social networking platforms 12 may be used with principles described herein. Social networking platforms 12 can be used to market to, and advertise to, users of the platforms 12. Although the principles described herein may apply to different social networking platforms 12, many of the examples are described with respect to Twitter to aid in the explanation of the principles.

More generally, social networks allow users to easily pass on information to all of their followers (e.g., re-tweet or @reply using Twitter) or friends (e.g., share using Facebook).

The terms “friend” and “follower” are defined below.

The term “follower”, as used herein, refers to a first user account (e.g. the first user account associated with one or more social networking platforms 12 accessed via a computing device) that follows a second user account (e.g. the second user account associated with at least one of the social networking platforms 12 of the first user account and accessed via a computing device), such that content posted by the second user account is published for the first user account to read, consume, etc. For example, when a first user follows a second user, the first user (i.e. the follower) will receive content posted by the second user. In some cases, a follower engages with the content posted by the other user (e.g., by sharing or reposting the content). The second user account is the “followee” and the follower follows the followee.

It will be appreciated that a user account is a known term in the art of computing. In some cases, although not necessarily, a user account is associated with an email address. A user has a user account and is identified to the computing system by a username (or user name). Other terms for username include login name, screen name (or screenname), nickname (or nick) and handle.

A “friend”, as used herein, is used interchangeably with a “followee”. In other words, a friend refers to a user account, for which another user account can follow. Put another way, a follower follows a friend.

A “social data network” or “social network”, as used herein includes one or more social data networks based on different social networking platforms 12. For example, a social network based on a first social networking platform 12 and a social network based on a second social networking platform 12 may be combined to generate a combined social data network. A target audience of users may be identified using the combined social data network, or also simply herein referred to as a “social data network” or “social network”.

Examples of social media intelligence applications 20 that can use or otherwise benefit from the results generated by the system 10 include, without limitation, Sysomos Influence (for determining top influencers and influencer communities), Sysomos MAP (for viral marketing), etc.

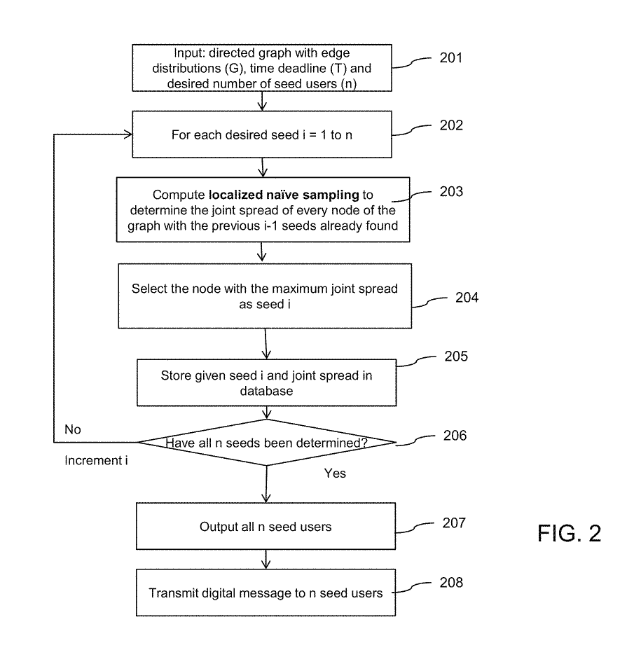

FIGS. 2, 3 and 4 show example computer executable or processor implemented instructions executed by the system 10.

In FIG. 2, at block 201, the following inputs are provided to the CPU 16: directed graph with edge distributions (G), time deadline (T) and desired number of seed users (n).

At block 202, a for-loop is established to execute a number of repeated operations. In particular, for each desired seed i=1 to n, the operations 203 to 206 are repeated.

At block 203, the system computes localized naïve sampling to determine the joint spread of every node of the graph together with the previous i−1 seeds already found. At block 204, the computing system automatically select the node with the maximum joint spread as seed i. At block 205, the computing system stores the given seed i and the joint spread in a database. At block 206, the computing system determines if all n seeds have been obtained. If not, the process repeats, going back to block 202 and with incrementing the value of i.

After all n seeds are obtained, the computing system outputs all n seed users (block 207). At block 208, the computing system transmits one or more digital messages to the n seed users.

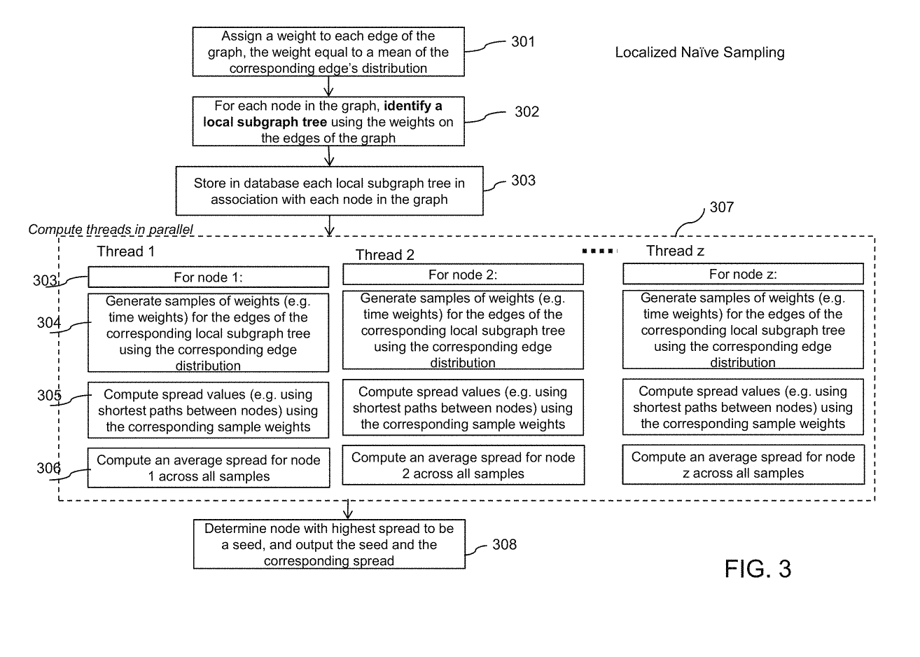

The process for implementing localized naïve sampling, as noted at block 203, includes calling the function or implementing the instructions set out in FIG. 3.

At block 301, the computing system assigns a weight to each edge of the graph, the weight equal to a mean of the corresponding edge's distribution. At block 302, for each node in the graph, the computing system identifies a local subgraph tree using the weights on the edges of the graph. At block 303, the computing system stores in a database each local subgraph tree in association with each node in the graph.

At block 307, the CPU 16 transmits data to the multi-processor platform 18 to process multiple threads in parallel.

In particular, each node is in the graph is associated with its own thread in the multi-processor platform. Therefore, computations of Node 1 are associated with Thread 1 (block 303). In particular, in Thread 1, at block 304, the multi-processor platform 18 generates samples of weights (e.g. time weights) for the edges of the corresponding local subgraph tree using the corresponding edge distribution. At block 305, the multi-processor platform 18 computes spread values (e.g. using shortest paths between nodes) using the corresponding sample weights. At block 306, the multi-processor platform 18 computes an average spread for Node 1 across all samples.

Thread 2 computes an average spread for Node 2 across all samples. Thread z computes an average spread for Node z across all samples. It will be appreciated that there are z nodes in the graph G. These computations in each thread occur in parallel, and the outputs are returned back to the CPU 16.

At block 308, the CPU 16 determines the node with highest spread to be a seed, and outputs the seed and the corresponding spread.

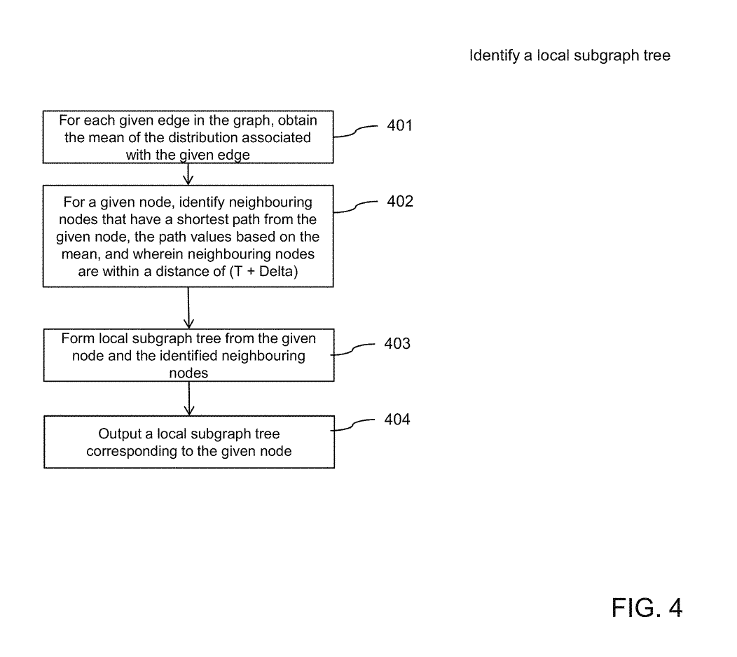

The process of identifying local subgraph tree, as per block 302, is explained in more detail in FIG. 4. It will be appreciated that the local subgraph tree may be, for example, a Dijkstra tree, but not necessarily. In general, other local subgraph trees obtained using shortest path methods are applicable.

At block 401, for each given edge in the graph, the computing system obtains the mean of the distribution associated with the given edge. At block 402, for a given node, the computing system identifies neighbouring nodes that have a shortest path from the given node, the path values based on the mean, and wherein neighbouring nodes are within a distance of (T+Delta). Delta is a relaxation parameter. For example, Delta is computed based on one or more the distributions of one or more edges. Delta may also be based on another parameter. At block 403, the computing system forms a local subgraph tree from the given node and the identified neighbouring nodes. At block 404, the computing system outputs a local subgraph tree corresponding to the given node.

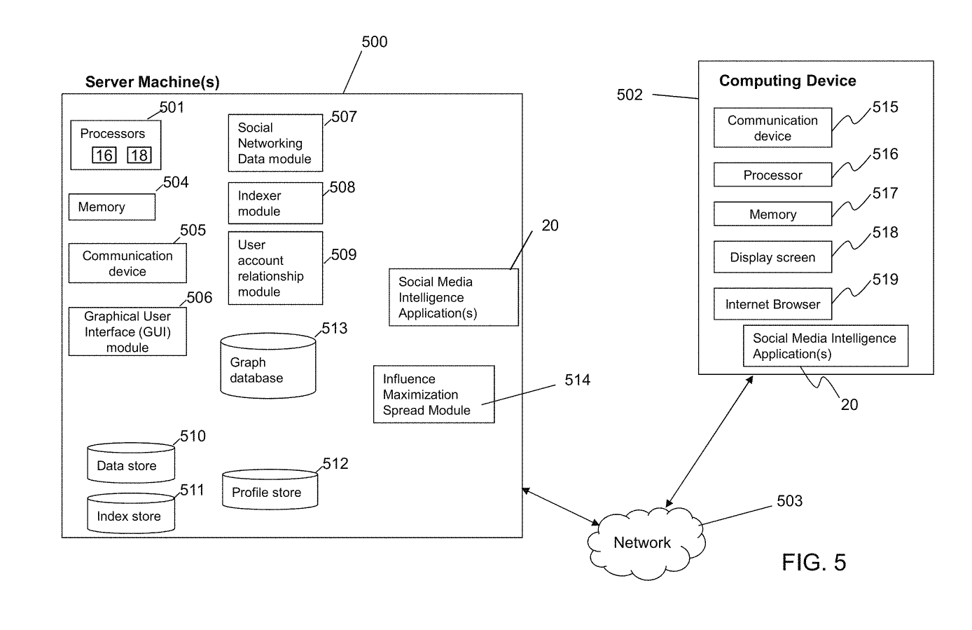

Turning to FIG. 5, a schematic diagram of a computing system is shown within which the influence maximization computations of determining the seed users S described above can be implemented. It can be appreciated that the server machines 500 shown in FIG. 5 can include processors 501 that operate as the CPU 16 and can include or otherwise have access to a multi-processor platform 18 such as a GPU. In an example embodiment, the platform 18 includes one or more GPUs provided by NVIDIA. The server machine(s) 500, also referred to herein as a server, is in communication with a computing device 502 over a data network 503. The server 500 obtains and analyzes social network data and provides results to the computing device 502 over the network 503. The computing device 502 can receive user inputs through a GUI to control parameters for performing or reviewing an analysis. For example, the parameter T for the time deadline can be provided by a user.

It can be appreciated that social network data includes data about the users of the social network platform, as well as the content generated or organized, or both, by the users. Non-limiting examples of social network data includes the user account ID or user name, a description of the user or user account, the messages or other data posted by the user, connections between the user and other users, location information, etc. An example of connections is a “user list”, also herein called “list”, which includes a name of the list, a description of the list, and one or more other users which the given user follows. The user list is, for example, created by the given user.

In an example embodiment, the server 500 includes a large amount of memory capacity. In another example embodiment, the memory device 504 or memory devices are solid state drives for increased read/write performance. In another example embodiment, multiple servers are used to implement the methods described herein. In other words, in an example embodiment, the server 500 refers to a server system. In another example embodiment, other currently known computing hardware or future known computing hardware is used, or both.

The server 500 also includes a communication device 505 to communicate via the network 503. The network 503 may be a wired or wireless network, or both. In an example embodiment, the server 500 also includes a GUI module 506 for displaying and receiving data via the computing device 502. The server 500 also includes: a social networking data module 507, an indexer module 508, and a user account relationship module 509. Other components or modules may also be utilized by or included in the server 500 even if not shown in this illustrative example. Similarly, other functionality can be implemented by the modules shown in FIG. 17.

The server 350 also includes a number of databases, including a data store 510, an index store 511, a user account profile store 512, and a database for storing social network graphs 513.

The social networking data module 507 is used to receive a stream of social networking data. In an example embodiment, millions of new messages are delivered to social networking data module 507 each day, and in real-time. The social networking data received by the social networking data module 507 is stored in the data store 510.

The indexer module 508 performs an indexer process on the data in the data store 510 and stores the indexed data in the index store 511. In an example embodiment, the indexed data in the index store 511 can be more easily searched, and the identifiers in the index store can be used to retrieve the actual data (e.g. full messages).

A social network graph G (e.g. the graph 14) is also obtained from the social networking platform server, and is stored in the social network graph database. The social network graph 14 can be used to identify all users “following” or connected to a queried user.

The profile store 512 stores meta data related to user profiles. Examples of profile related meta data include the aggregate number of followers of a given user, self-disclosed personal information of the given user, location information of the given user, etc. The data in the profile store 512 can be queried.

In an example embodiment, the user account relationship module 509 can use the social network graph 14 and the profile store 512 to determine which users are following a particular user. In other words, a user can be identified as “friend” or “follower”, or both, with respect to one or more other users. The module 509 may also configured to determine relationships between user accounts, including reply relationships, mention relationships, and re-post relationships.

The server 350 in this example also includes an influencer maximization spread module 514 to output seed users S.

The computing device 502 includes a communication device 515 to communicate with the server 500 via the network 503, a processor 516, a memory device 517, a display screen 518, and an Internet browser 519. In an example embodiment, the GUI provided by the server 500 is displayed by the computing device through the Internet browser. In another example embodiment, the social media intelligence application 20 resides on the computing device 502, or on the server 500, or both. It can be appreciated that the display screen may be part of the computing device (e.g. as with a mobile device, a tablet, a laptop, a wearable computing device, etc.) or may be separate from the computing device (e.g. as with a desktop computer, or the like).

Although not shown, various user input devices (e.g. touch screen, roller ball, optical mouse, buttons, keyboard, microphone, etc.) can be used to facilitate interaction between the user and the computing device 348.

It will be appreciated that, in another example embodiment, the system includes multiple server machines. In another example embodiment, there are multiple computing devices that communicate with the one or more servers.

### Experiments

This section outlines empirical evaluation on the proposed framework and it offers a comparison vs. the state-of-the-art in terms of three distinct criteria: quality of the solutions produced (seed sets), running time and peak memory consumption.

Real World Dataset Statistics

We base our evaluation on real world networks that are offered by the Standford Network Analysis Project (SNAP). Table 1 shows some of the basic statistics regarding the networks that are used.

For the networks of Table 1, we associate each directed edge with a pairwise transmission rate obeying an exponential density. For each edge, we select the scale parameter of the corresponding density uniformly at random from 0 to 5.

Towards the goal of comparing the quality of seed sets that are produced by ConTinEst and our methodology, we need a procedure that can receive these sets as input and analytically compute the expected influence spread. This implies the use of exhaustive search algorithms, or the INFLUMAX framework. However, these algorithms cannot accommodate this comparison, as they do not scale at the size of networks used here. Instead, we perform an immediate comparison between our method and ConTinEst, since the latter has been shown to statistically outperform other approximation methods for real world data.

Comparisons:
Spread vs # nodes for gnutella04, gnutella08, wikivote, facebook (Dijkstra Trees, Continest, High-degree)
Running time vs network size for all graphs and for T=0.1, T=0.2 (Dijkstra CPU/GPU, ConTinest CPU/GPU). Whenever ConTinest GPU does not scale we don't report. Same for DijkstraTrees CPU.
Running time vs network density for soc-Epinions (Dijkstra GPU vs ConTinest CPU)
Peak mem vs network size for all graphs (Dijkstra GPU vs ConTinest CPU)

TABLE 1
Network Statistics

| Network | # nodes | # edges | density |
|---|---|---|---|
| ego-Facebook | 4,039 | 88,234 | 21.84 |
| gnutella08 | 6,301 | 20,777 | 3.29 |
| wiki-vote | 7,115 | 103,689 | 14.57 |
| gnutella04 | 10,876 | 39,994 | 3.68 |
| soc-Epinions1 | 75,879 | 508,837 | 6.71 |
| ego-twitter | 81,306 | 1,768,149 | 21.75 |
| soc-Slashdot0922 | 82,168 | 948,464 | 11.54 |

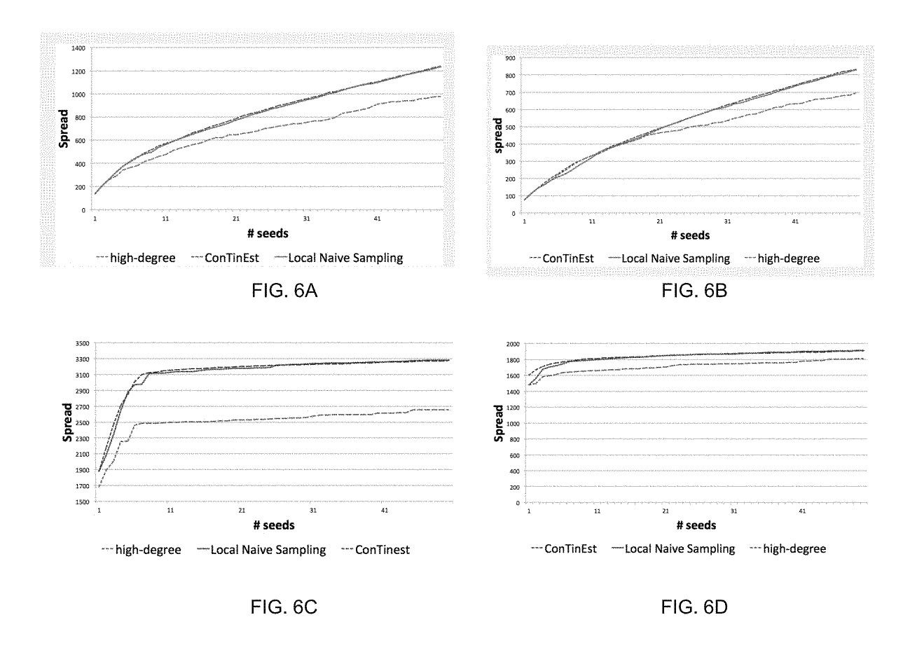

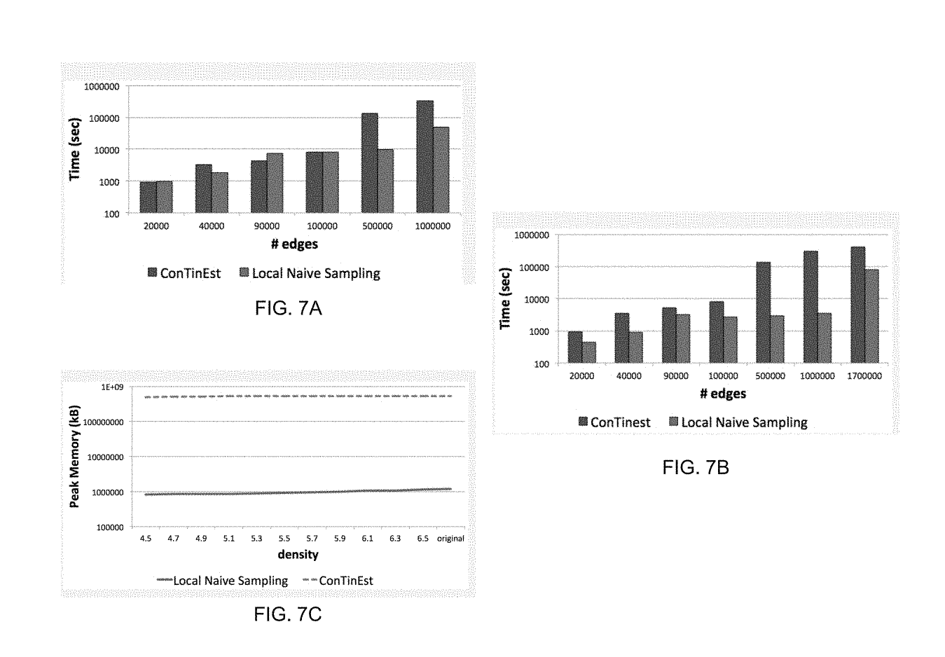

Further results are shown in FIGS. 6A-6D, and FIGS. 7A-7D.

It will also be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 10, any component of or related to the system 10, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A multi-processor computing system comprising:
a processor;
a graphics processing unit (GPU);
a memory;
the system configured to:
obtain a directed graph,
separate the graph into local subgraphs for each node in the graph,
compute for each of the local subgraphs, in parallel using the GPU, localized naive sampling to output a number user accounts represented as nodes in the graph.

2. The computing system of claim 1 wherein the processor is configured to obtain the directed graph and separate the graph into the local subgraphs for each node in the graph.

3. The computing system of claim 1 wherein the local subgraphs for each node in the graph are stored in the memory, and the processor is further configured to transmit the local subgraphs to the GPU.

4. The computing system of claim 1 wherein each one of the local subgraphs is assigned to its respective thread in the GPU for parallel processing, and each respective thread in the GPU produces an output.

5. The computing system of claim 4 wherein the output from each respective thread in the GPU is transmitted to the processor and, in response, the processor is configured to determine a node in the graph with a highest spread value.

6. The computing system of claim 1 wherein the processor is configured to compute a given local subgraph for a given node in the graph by: computing a mean of the distribution associated with each given edge in the graph; compute neighboring nodes to the given node; and forming the given local subgraph comprising the given node and the neighboring nodes.

7. The computing system of claim 1 wherein the directed graph represents users in a social data network.

8. The computing system of claim 7 wherein the system is further configured to obtain a time deadline T and a desired number of seed users n, wherein the time deadline T is an amount of time in which a digital message should reach a desired number of the users in the social data network after transmitting the digital message to the seed users.

9. The computing system of claim 8 wherein the number of user accounts outputted matches the desired number of seed users n.

10. The computing system of claim 8 wherein the digital message is any one or more of: a Tweet, a text message, a posting, an image, an audio file, a video, a tag, and a location.

11. A multi-processor computing system comprising:
a central processing unit (CPU);
a multi-processor platform;
a memory storing a social media application and a directed graph that represents users in a social data network;
the system configured to:
receive an input from the social media application comprising a time deadline T and a desired number of seed users n, wherein the time deadline T is an amount of time in which a digital message should reach a desired number of the users in the social data network after transmitting the digital message to the seed users;
separate the graph into local subgraphs for each node in the graph;
compute for each of the local subgraphs, in parallel using the multi-processor platform, localized naive sampling to output seed user accounts represented as nodes in the graph; and
return the outputted seed user accounts to the social media application, wherein the number of the outputted seed user accounts matches the desired number of seed users n.

12. The computing system of claim 11 wherein the CPU is configured to obtain the directed graph and separate the graph into the local subgraphs for each node in the graph.

13. The computing system of claim 11 wherein the local subgraphs for each node in the graph are stored in the memory, and the CPU is further configured to transmit the local subgraphs to the multi-processor platform.

14. The computing system of claim 11 wherein each one of the local subgraphs is assigned to its respective thread in the multi-processor platform for parallel processing, and each respective thread in the multi-processor platform produces an output.

15. The computing system of claim 14 wherein the output from each respective thread in the multi-processor platform is transmitted to the CPU and, in response, the CPU is configured to determine a node in the graph with a highest spread value.

16. The computing system of claim 11 wherein the CPU is configured to compute a given local subgraph for a given node in the graph by: computing a mean of the distribution associated with each given edge in the graph; compute neighboring nodes to the given node; and forming the given local subgraph comprising the given node and the neighboring nodes.

17. The computing system of claim 11 wherein the digital message is any one or more of: a Tweet, a text message, a posting, an image, an audio file, a video, a tag, and a location.

18. The computing system of claim 11 wherein the multi-processor platform comprises one or more graphics processing units (GPUs).
